(19) United States
(12) Patent Application Publication
(10) Pub. No.: US 2015/0213786 A1
(43) Pub. Date: Jul. 30, 2015

(54) METHOD FOR CHANGING A RESOLUTION OF AN IMAGE SHOWN ON A DISPLAY

(71) Applicant: Nvidia Corporation, Santa Clara, CA (US)

(72) Inventors: Yusuf Mamajiwala, Pune (IN); Chetan Agarwal, Pune (IN)

(73) Assignee: Nvidia Corporation, Santa Clara, CA (US)

(21) Appl. No.: 14/165,306

(22) Filed: Jan. 27, 2014

(51) Int. Cl. G09G 5/391; G09G 5/00; G06K 9/00; G06T 3/40

(52) U.S. Cl. CPC G09G 5/391; G06T 3/40; G09G 5/003; G06K 9/00255; G09G 2354/00; G09G 2340/0407; G09G 2320/08

(57) ABSTRACT

Provided is a method for changing a resolution of an image shown on a display. The method, in one embodiment, includes, providing an image on a display, and detecting a relative distance of an object to the display. The method, in this embodiment, further includes changing a resolution of the image as the relative distance changes.

### TECHNICAL FIELD

This application is directed, in general, to image display and, more specifically, to a method for changing a resolution of an image shown on a display, and an electronic device for accomplishing the same.

### BACKGROUND

Computers of all types and sizes, including desktop computers, laptop computers, tablets, smart phones, etc., typically embody the ability to change a resolution of the image being displayed. Typically, the resolution is changed by going into a settings feature and physically modifying the resolution (whether up or down) based upon the desires of the user. Unfortunately, the process for modifying the resolution is time consuming, among other drawbacks. What is needed is an improved method for changing the operational resolution of a display, as well as an electronic device for accomplishing the same.

### SUMMARY

One aspect provides a method for changing a resolution of an image shown on a display. The method, in one embodiment, includes, providing an image on a display, and detecting a relative distance of an object to the display. The method, in this embodiment, further includes changing a resolution of the image as the relative distance changes.

Another aspect provides an electronic device. The electronic device, in this aspect, includes a display having a proximity sensor associated therewith, and storage and processing circuitry associated with the display and the proximity sensor. The storage and processing circuitry, in this embodiment, is operable to 1) provide an image on the display, 2) detect a relative distance of an object to the display, and 3) change a resolution of the image as the relative distance changes.

### BRIEF DESCRIPTION

Reference is now made to the following descriptions taken in conjunction with the accompanying drawings, in which:

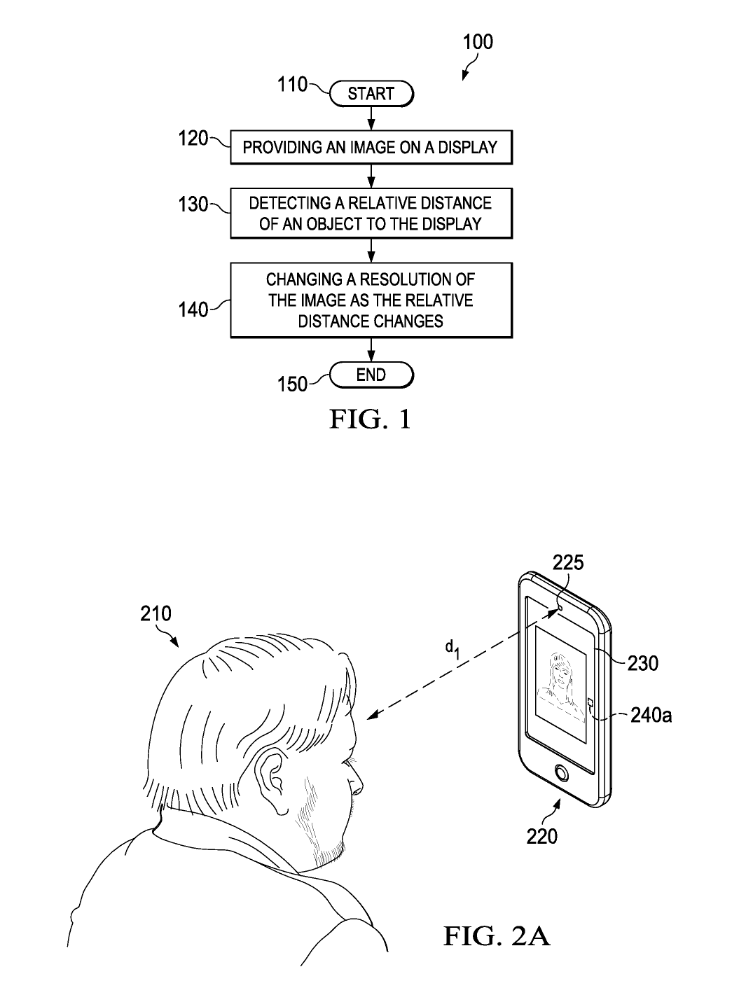

FIG. 1 a flow diagram of one embodiment of a method for changing a resolution of an image shown on a display;

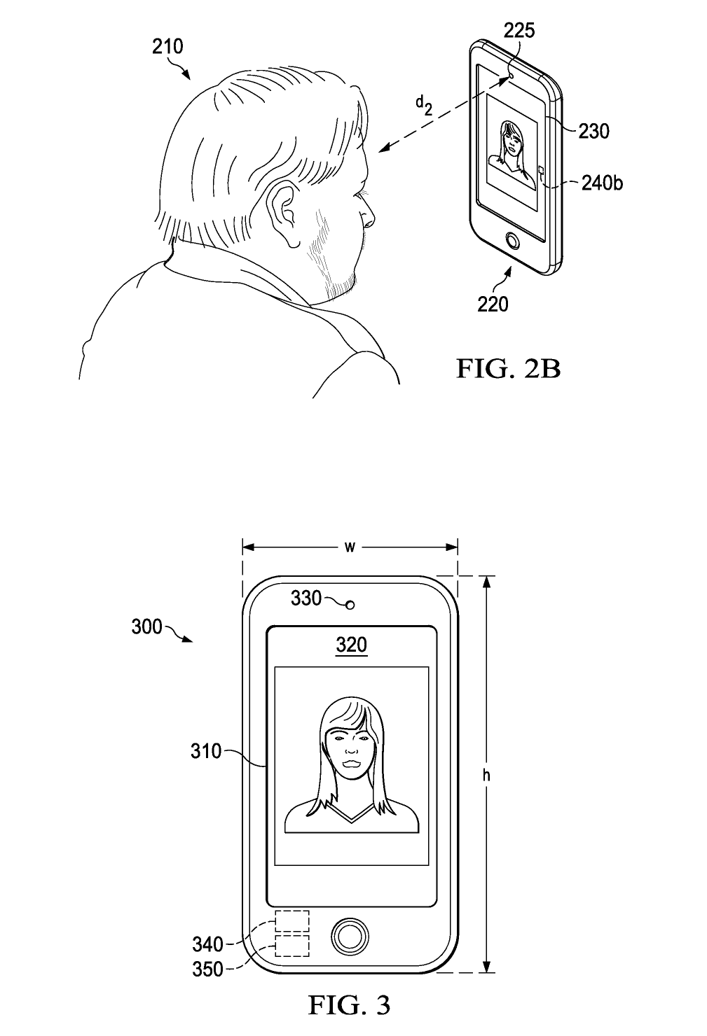

FIGS. 2A-2B illustrate different aspects of the change in resolution feature;

FIG. 3 illustrates aspects of a representative embodiment of an electronic device in accordance with embodiments of the disclosure;

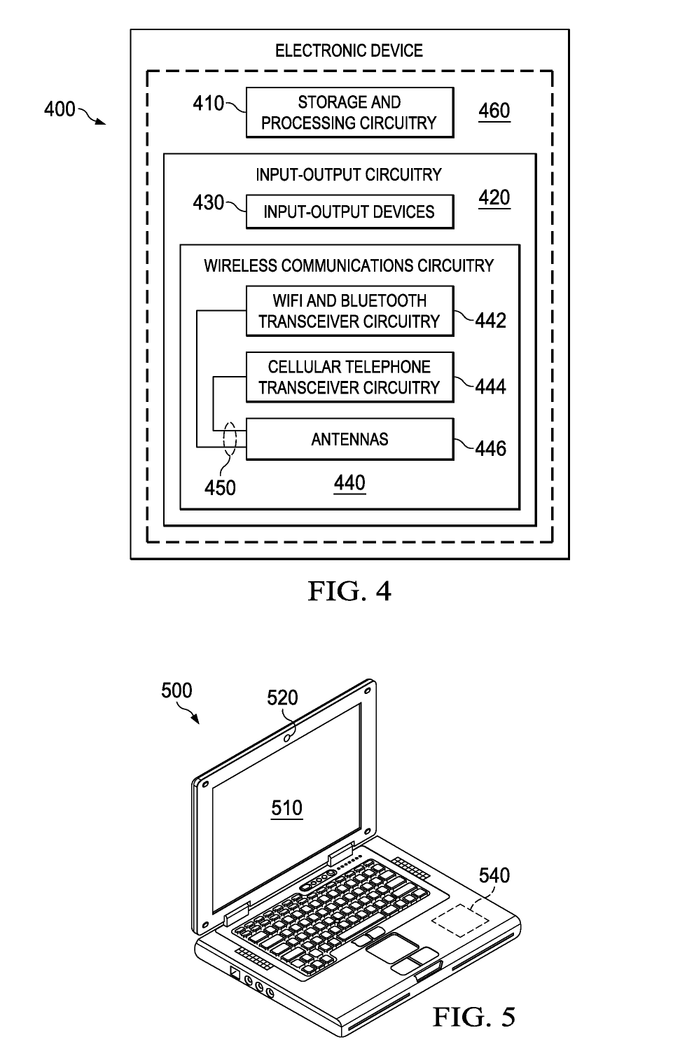

FIG. 4 illustrates a schematic diagram of electronic device manufactured in accordance with the disclosure; and

FIGS. 5-7 illustrate alternative aspects of a representative embodiment of an electronic device in accordance with embodiments of the disclosure.

### DETAILED DESCRIPTION

The present disclosure is based, at least in part, on the acknowledgement that traditional methods for changing a resolution of an image shown on a display are unnatural. With this acknowledgment in mind, the present disclosure has recognized that if a proximity sensor (e.g., one that measures the distance from the display to an object) were associated with the display, the proximity sensor could detect movement of the display relative to the object, and accordingly change a resolution of the image as the relative distance changes. For example, if the proximity sensor detected that the display was being moved closer to the object (e.g., a user's head in one embodiment) a resolution of the image shown on the display would begin to increase. Alternatively, if the proximity sensor detected that the display was being moved further away from the object, a resolution of the image being shown on the display would begin to decrease. The above discussions focus on the movement of the display relative to the object, but those skilled in the art understand that any relative movement of the two would have the same effect.

The present disclosure has further recognized that the object will traditionally be a user of the device. Accordingly, it is important to know the relative location of the user of the device with respect to the device itself. Moreover, since the head of the user is what often matters, in one embodiment, it is the relative location of the user's head (e.g., eyes in one embodiment) to the device itself that is measured. In this embodiment, a face detection algorithm could be used to pin point the user's head (e.g., eyes). With this information, the resolution of the image could be modified based upon the distance between the user's head and the display.

The present disclosure has further recognized that the aforementioned change in resolution feature can be user customizable. For example, the user of the device having this feature could customize the settings based upon the type of display being used. As an example, the amount of resolution change might be different for a 60 inch television than it might be for a smart phone. Accordingly, the feature could be adjusted for the type of display being used. Similarly, certain individuals might view a display having a given resolution from one distance, wherein another individual might view the same display having the given resolution from a different distance. Accordingly, the various features of the resolution change feature could be customized for the individual user, including the proportions that the resolution changes based upon an amount of change in relative distance. In one embodiment, the change is resolution is proportional to the change in distance. In another embodiment, the resolution incrementally changes (e.g., in steps) as the distance changes.

The above discussion focuses on the ability of the user to precisely define one or more parameters for the change in resolution feature. Other embodiments may exist wherein the user is limited to a select few options for programming the change in resolution feature. Yet other embodiments may exist wherein the change in resolution feature may only be turned on and/or turned off by the user. Even yet other embodiments exist wherein the change in resolution features are pre-programmed and may not be modified in any way by the user.

FIG. 1 is a flow diagram 100 of one embodiment of a method for changing a resolution of an image shown on a display. The method for changing resolution begins in a start step 110 and continues on to step 120 wherein an image is provided on a display. The term “image” as it is used throughout this disclosure includes anything that is being displayed, whether in still or video form. Accordingly, the term “image” includes photo type stills images and video images, games displayed as still images or video images, internet depictions displayed as still images or video images, software applications (e.g., word processors) displayed as still images or video images, or any other item being displayed as a still image or video image. Accordingly, the method disclosed herein is equally applicable to still images and video images, including high definition and 3-dimensional images as well. Moreover, the image being provided on the display may be an image that originated from the electronic device having the display, or alternatively could have been an image that originated elsewhere, and was transferred by wire or wireless means to the electronic device having the display.

In a step 130, a relative distance from an object to the display is detected. In one embodiment, a proximity sensor detects the relative distance between the display and a user of the electronic device. In another embodiment, the proximity sensor detects the relative distance between the display and a user's head, or eyes.

The proximity sensor may comprise a variety of different configurations and remain within the purview of the disclosure. In one embodiment, the proximity sensor is part of a camera associated with the electronic device. In another embodiment, the proximity sensor is an infrared sensor associated with the electronic device. Other known proximity sensors, whether currently known or hereafter discovered, are within the scope of the disclosure.

The proximity sensor, in one embodiment, is configured to detect changes in distance between the user of the electronic device and the electronic device itself. For example, in one embodiment the proximity sensor detects changes in distance between the head of the user and the device itself. Those skilled in the art understand that sophisticated, but well known, face detection technologies and algorithms might be required to track changes in distance between the user's head and the electronic device.

Knowing the relative distance between the object and the display, in a step 140, a resolution of the image changes as the relative distance changes. For example, as the relative distance decreases the resolution of the image might increase. Alternatively, as the relative distance increases the resolution of the image might decrease. As discussed above, the resolution might change in proportion to the change in distance. In another embodiment, the resolution changes in increments as the distance changes.

The change in resolution feature, in one embodiment, may also be user definable. For example, the user of the electronic device might program the change in resolution feature based upon predefined standard settings, including the type of device being used, and the size of the display. Alternatively, the user of the electronic device might program the change in resolution feature based upon customized settings, including the typical distance that user prefers to view the screen, at what distances the user would like the image to stop changing resolution, how the user would like to engage/disengage the change in resolution feature, the proportional change in resolution that occurs for an amount of change in relative distance, etc. Those skilled in the art understand the myriad of different features that could be user defined.

In one embodiment, each of the steps 120, 130, 140 occur at substantially real-time speeds. The phrase “substantially real-time speeds”, as used herein, means the process of steps 120, 130, 140 can be timely used for viewing videos. In those scenarios wherein a lag occurs that substantially impedes the video display, steps 120, 130 and 140 are not occurring at substantially real-time speeds. The method for changing resolution would conclude in an end step 150.

Heretofore the present disclosure, the disclosed method was unrealistic to achieve. Specifically, the present disclosure benefits from a multitude of factors that have only recently (e.g., as a whole) been accessible. For example, only recently has image processing software been readily accessible to accomplish the desires stated above, for example in real-time. Additionally, only recently have electronic devices, particularly mobile electronic devices, had the capability to run the image processing software, for example in substantially real-time speeds. Likewise, proximity sensors have only recently reduced in price to a level that it is economical, and thus feasible, to associate them with a display, or in the case of mobile electronic devices, within the housing along with the display.

The inclusion of the change in resolution feature has many benefits. First, the change in resolution feature, in certain configurations, automatically presents the best image to the user. Additionally, by lowering the resolution, particularly when it will not affect the quality and the user's experience, a great amount of processing can be saved. Accordingly, the overall system will be more efficient. Additionally, power consumption will likely decrease, which presents a significant improvement over prior art methods/devices.

FIGS. 2A-2B illustrate different aspects of the change in resolution feature. Specifically, FIGS. 2A-2B illustrate a user 210 viewing an image 240 shown on a display 230 of an electronic device 220. As shown in FIG. 2A, at a distance d₁, for example measured using the proximity sensor 225, the image 240a has given resolution. In fact, in the embodiment shown, the resolution of the image 240a is such that it is somewhat grainy. However, as the relative distance changes from d₁ to d₂, wherein d₁ is greater than d₂, a resolution of the image 240b improves. In fact, the image 240b is much more easy to discern (e.g., less grainy) than the image 240a.

While FIGS. 2A-2B illustrate distances d₁ and d₂, wherein d₁ is greater than d₂, the electronic device may be configured to have a dₘₐₓ and dₘᵢₙ distances as well. For example, the electronic device might be configured such that once the relative distance exceeds the dₘₐₓ value a resolution of the image will not decrease any further. Similarly, the electronic device might be configured such that once the relative distance goes below the dₘᵢₙ value a resolution of the image will not improve in any further. The dₘₐₓ and dₘᵢₙ values, in accordance with the disclosure, may be user definable.

Moreover, FIGS. 2A-2B illustrate a significant amount of change in resolution based upon what appears to be very little change in the relative distance between the display 230 and the user 210. As indicated above, the proportion at which the resolution of the image changes as it relates to the change in relative distance may be user definable. Moreover, such proportions will likely vary based upon the type and size of display. Whereas a smart phone user might desire to change the resolution by about 20% by moving the smart phone just 6 inches closer to the user, a 60 inch television user might desire a 24 inch movement before the resolution changes by about 20%.

It should also be noted that the change in resolution feature might not engage until a predefined amount of movement is detected. For example, it might be undesirable for the resolution of the image to change based upon slight movements of the head toward or away from the device. Accordingly, the device might be configured such that the change in resolution feature is not engaged until a threshold movement is met. Again, this threshold value will likely change depending on the type and size of the device being used, and likely may be user definable.

It should equally be noted that the user of the device should have the ability to engage or disengage the change in resolution feature as desired. This could be accomplished through a menu on the device or a dedicated button on the device. Alternatively, the device could be programed to look for a certain gesture on the part of the user to engage or disengage the change in resolution feature. For example, the device could be programmed such that two slow blinks of the user's eyes engages/disengages the change in resolution feature. Other sound and/or image based gestures, among others, might be used to engage/disengage the change in resolution feature. The above-discussed face detection algorithm would be helpful with this.

FIG. 3 illustrates aspects of a representative embodiment of an electronic device 300 in accordance with embodiments of the disclosure. The electronic device 300 illustrated in FIG. 3 is depicted as a mobile electronic device. Examples of mobile electronic devices include smart phones (e.g., cellphones), tablet computers, handheld computers, ultraportable computers, laptop computers, a combination of such devices, or any other suitable portable electronic device including wireless communications circuitry. Notwithstanding, other electronic devices, including desktop computers, televisions, projectors, etc., as well as certain other electronic devices without wireless communications circuitry, are within the purview of this disclosure.

The electronic device 300 of FIG. 3 includes a display 310. The display 310, in one embodiment, is configured to display an image 320. The display 310, in accordance with the disclosure, includes a proximity sensor 330 associated therewith. For example, the proximity sensor 330 might form at least a portion of a camera associated with the electronic device 300. In an alternative embodiment, the proximity sensor 330 might comprise an infrared sensor. In the given example, proximity sensor 330 is not only associated with the electronic device 300, but forms and integral part of the electronic device 300. This is particularly useful when the electronic device 300 is configured as a mobile electronic device. However, certain other embodiments (discussed briefly below) exist wherein the proximity sensor 330 attaches to, or is positioned proximate to, the electronic device 300.

The electronic device 300 further includes storage and processing circuitry 340. The storage and processing circuitry 340, in one embodiment, is associated with the display 310 and proximity sensor 330. In accordance with the disclosure, the storage and processing circuitry 340, among other jobs, is operable to provide an image 320 on the display 310, detect a relative distance of an object to the display 310, and change a resolution of the image 320 as the relative distance changes, for example as discussed above with regard to FIGS. 1 and 2A-2B.

The electronic device 300, in one embodiment, may further include wireless communications circuitry 350. The wireless communications circuitry 350 may include one or more antennas. In accordance with the disclosure, the wireless communications circuitry may be used to receive the image 320 from another electronic device.

FIG. 4 shows a schematic diagram of electronic device 400 manufactured in accordance with the disclosure. Electronic device 400 may be a portable device such as a mobile telephone, a mobile telephone with media player capabilities, a handheld computer, a remote control, a game player, a global positioning system (GPS) device, a laptop computer, a tablet computer, an ultraportable computer, a combination of such devices, or any other suitable portable electronic device. Electronic device 400 may additionally be a desktop computer, television, or projector system.

As shown in FIG. 4, the electronic device 400 may include storage and processing circuitry 410. Storage and processing circuitry 410 may include one or more different types of storage such as hard disk drive storage, nonvolatile memory (e.g., flash memory or other electrically-programmable-read-only memory), volatile memory (e.g., static or dynamic random-access-memory), etc. The processing circuitry may be used to control the operation of device 400. The processing circuitry may be based on a processor such as a microprocessor and other suitable integrated circuits. With one suitable arrangement, storage and processing circuitry 410 may be used to run software on device 400, such as change in resolution algorithms, face detection algorithms, etc., as might have been discussed above with regard to previous FIGS. The storage and processing circuitry 410 may, in another suitable arrangement, be used to run internet browsing applications, voice-over-internet-protocol (VOIP) telephone call applications, email applications, media playback applications, operating system functions, etc. Storage and processing circuitry 410 may be used in implementing suitable communications protocols.

Communications protocols that may be implemented using storage and processing circuitry 410 include, without limitation, internet protocols, wireless local area network protocols (e.g., IEEE 802.11 protocols—sometimes referred to as WiFi®), protocols for other short-range wireless communications links such as the Bluetooth® protocol, protocols for handling 3G communications services (e.g., using wide band code division multiple access techniques), 2G cellular telephone communications protocols, etc. Storage and processing circuitry 410 may implement protocols to communicate using cellular telephone bands at 850 MHz, 900 MHz, 1800 MHz, and 1900 MHz (e.g., the main Global System for Mobile Communications or GSM cellular telephone bands) and may implement protocols for handling 3G and 4G communications services.

Input-output device circuitry 420 may be used to allow data to be supplied to device 400 and to allow data to be provided from device 400 to external devices. Input-output devices 430 such as touch screens and other user input interfaces are examples of input-output circuitry 420. Input-output devices 430 may also include user input-output devices such as buttons, joysticks, click wheels, scrolling wheels, touch pads, key pads, keyboards, microphones, cameras, etc. A user can control the operation of device 400 by supplying commands through such user input devices. Display and audio devices may be included in devices 430 such as liquid-crystal display (LCD) screens, light-emitting diodes (LEDs), organic light-emitting diodes (OLEDs), and other components that present visual information and status data. Display and audio components in input-output devices 430 may also include the aforementioned proximity sensor, as well as audio equipment such as speakers and other devices for creating sound. If desired, input-output devices 430 may contain audio-video interface equipment such as jacks and other connectors for external headphones and monitors.

Wireless communications circuitry 440 may include radio-frequency (RF) transceiver circuitry formed from one or more integrated circuits, power amplifier circuitry, low-noise input amplifiers, passive RF components, one or more antennas, and other circuitry for handling RF wireless signals. Wireless signals can also be sent using light (e.g., using infrared communications). Wireless communications circuitry 440 may include radio-frequency transceiver circuits for handling multiple radio-frequency communications bands. For example, circuitry 440 may include transceiver circuitry 442 that handles 2.4 GHz and 5 GHz bands for WiFi® (IEEE 802.11) communications and the 2.4 GHz Bluetooth® communications band. Circuitry 440 may also include cellular telephone transceiver circuitry 444 for handling wireless communications in cellular telephone bands such as the GSM bands at 850 MHz, 900 MHz, 1800 MHz, and 1900 MHz, as well as the UMTS and LTE bands (as examples). Wireless communications circuitry 440 can include circuitry for other short-range and long-range wireless links if desired. For example, wireless communications circuitry 440 may include global positioning system (GPS) receiver equipment, wireless circuitry for receiving radio and television signals, paging circuits, etc. In WiFi® and Bluetooth® links and other short-range wireless links, wireless signals are typically used to convey data over tens or hundreds of feet. In cellular telephone links and other long-range links, wireless signals are typically used to convey data over thousands of feet or miles.

Wireless communications circuitry 440 may include one or more antennas 446. Device 400 may be provided with any suitable number of antennas. There may be, for example, one antenna, two antennas, three antennas, or more than three antennas, in device 400. In accordance with that discussed above, the antennas may handle communications over multiple communications bands. If desired, a dual band antenna may be used to cover two bands (e.g., 2.4 GHz and 5 GHz). Different types of antennas may be used for different bands and combinations of bands. For example, it may be desirable to form an antenna for forming a local wireless link antenna, an antenna for handling cellular telephone communications bands, and a single band antenna for forming a global positioning system antenna (as examples).

Paths 450, such as transmission line paths, may be used to convey radio-frequency signals between transceivers 442 and 444, and antenna 446. Radio-frequency transceivers such as radio-frequency transceivers 442 and 444 may be implemented using one or more integrated circuits and associated components (e.g., power amplifiers, switching circuits, matching network components such as discrete inductors, capacitors, and resistors, and integrated circuit filter networks, etc.). These devices may be mounted on any suitable mounting structures. With one suitable arrangement, transceiver integrated circuits may be mounted on a printed circuit board. Paths 450 may be used to interconnect the transceiver integrated circuits and other components on the printed circuit board with antenna structures in device 400. Paths 450 may include any suitable conductive pathways over which radio-frequency signals may be conveyed including transmission line path structures such as coaxial cables, microstrip transmission lines, etc.

The device 400 of FIG. 4 further includes a chassis 460. The chassis 460 may be used for mounting/supporting electronic components such as a battery, printed circuit boards containing integrated circuits and other electrical devices, etc. For example, in one embodiment, the chassis 460 positions and supports the storage and processing circuitry 410, and the input-output circuitry 420, including the input-output devices 430 and the wireless communications circuitry 440 (e.g., including the WIFI and Bluetooth transceiver circuitry 442, the cellular telephone circuitry 444, and the antennas 446).

The chassis 460 may be made of various different materials, including metals such as aluminum. The chassis 460 may be machined or cast out of a single piece of material. Other methods, however, may additionally be used to form the chassis 460.

FIG. 5 illustrates alternative aspects of a representative embodiment of an electronic device 500 in accordance with embodiments of the disclosure. The electronic device 500 of FIG. 5 is configured as a laptop computer. The electronic device 500 includes many of the features of the electronic device 300 of FIG. 3, including a display 510 having a proximity sensor 520 associated therewith. The electronic device 500, similar to the electronic device 300, further includes storage and processing circuitry 540. The storage and processing circuitry 540, in accordance with this disclosure, is operable to accomplish the method discussed above with regard to FIGS. 1 and 2A-2B.

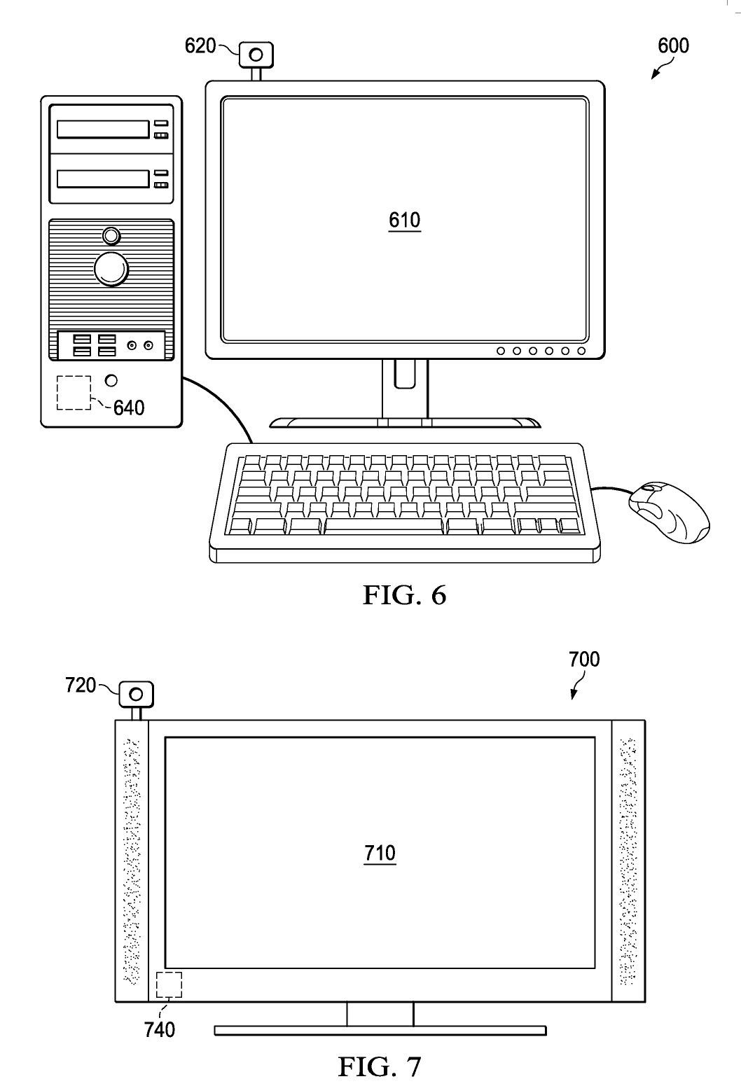

FIG. 6 illustrates alternative aspects of a representative embodiment of an electronic device 600 in accordance with embodiments of the disclosure. The electronic device 600 of FIG. 6 is configured as a desktop computer. The electronic device 600 includes many of the features of the electronic device 300 of FIG. 3, including a display 610 having a proximity sensor 620 associated therewith. The proximity sensor 620, in this embodiment, is attached to (e.g., as opposed to as a part of) the display 610. The electronic device 600, similar to the electronic device 300, further includes storage and processing circuitry 640. The storage and processing circuitry 640, in accordance with this disclosure, is operable to accomplish the method discussed above with regard to FIGS. 1 and 2A-2B.

FIG. 7 illustrates alternative aspects of a representative embodiment of an electronic device 700 in accordance with embodiments of the disclosure. The electronic device 700 of FIG. 7 is configured as a television. The electronic device 700 includes many of the features of the electronic device 300 of FIG. 3, including a display 710 having a proximity sensor 720 associated therewith. The proximity sensor 720, in this embodiment, is attached to (e.g., as opposed to as a part of) the display 710. The electronic device 700, similar to the electronic device 300, further includes storage and processing circuitry 740. The storage and processing circuitry 740, in accordance with this disclosure, is operable to accomplish the method discussed above with regard to FIGS. 1 and 2A-2B.

Those skilled in the art to which this application relates will appreciate that other and further additions, deletions, substitutions and modifications may be made to the described embodiments.

What is claimed is:

1. A method for changing a resolution of an image shown on a display, comprising:
providing an image on a display;
detecting a relative distance of an object to the display; and
changing a resolution of the image as the relative distance changes.

2. The method of claim 1, wherein as the relative distance decreases the resolution increases and as the relative distance increases the resolution decreases.

3. The method of claim 1, wherein detecting a relative distance of an object includes detecting a relative distance of a user.

4. The method of claim 3, wherein detecting a relative distance of a user includes detecting a relative distance of a user's head.

5. The method of claim 4, wherein detecting a relative distance of a user's head includes implementing a face detection algorithm to ascertain the user's head.

6. The method of claim 1, wherein detecting a relative distance of an object to the display includes using a camera to detect the relative distance of the object to the display.

7. The method of claim 1, wherein detecting a relative distance of an object to the display includes using an infrared sensor to detect the relative distance of the object to the display.

8. The method of claim 1, wherein the changing the resolution of the image as the relative distance changes is user engageable/disengageable.

9. The method of claim 1, wherein the resolution incrementally changes as the relative distance changes.

10. The method of claim 1, wherein an amount of resolution change of the image is proportional to an amount of change in relative distance.

11. An electronic device, comprising:
a display having a proximity sensor associated therewith; and
storage and processing circuitry associated with the display and the proximity sensor, the storage and processing circuitry operable to:
provide an image on the display;
detect a relative distance of an object to the display; and
changing a resolution of the image as the relative distance changes.

12. The electronic device of claim 11, wherein the storage and processing circuitry is operable to increase the resolution as the relative distance decreases and decrease the resolution as the relative distance increases.

13. The electronic device of claim 11, wherein the storage and processing circuitry is operable to detect a relative distance of a user of the electronic device.

14. The electronic device of claim 13, wherein the storage and processing circuitry is operable to detect a relative distance of a user's head of the electronic device.

15. The electronic device of claim 14, wherein the storage and processing circuitry implements a face detection algorithm operable to ascertain the user's head.

16. The electronic device of claim 11, wherein the proximity sensor is a camera.

17. The electronic device of claim 11, wherein the proximity sensor is an infrared sensor.

18. The electronic device of claim 11, wherein an amount of resolution change of the image is proportional to an amount of change in relative distance.

19. The electronic device of claim 11, wherein the proximity sensor is integral with the display.

20. The electronic device of claim 11, wherein the display, proximity sensor and storage and processing circuitry form a portion of a device selected from the group consisting of:
a desktop computer;
a laptop computer;
a tablet computer;
handheld computer;
a smart phone;
a television; and
a projector.
